(19) United States
(12) Patent Application Publication
(10) Pub. No.: US 2026/0254385 A1
(43) Pub. Date: Aug. 27, 2026

(54) CONTROL FOR MUTUALLY COUPLED SWITCHED RELUCTANCE MOTOR WITH DOUBLE-LAYER WINDING

(71) Applicant: Joy Global Longview Operations LLC, Longview, TX (US)

(72) Inventors: Joshua Ross Weaver, Longview, TX (US); William A. Dorsett, Orlando, FL (US); Ryosuke Hashimoto, Tyler, TX (US)

(21) Appl. No.: 19/544,557

(22) Filed: Feb. 19, 2026

Related U.S. Application Data
(60) Provisional application No. 63/761,686, filed on Feb. 21, 2025.

(51) Int. Cl. H02P 21/22; H02K 1/24; H02K 11/00; H02K 11/33; H02P 21/34

(52) U.S. Cl. CPC H02P 21/22; H02K 1/24; H02K 11/0094; H02K 11/33; H02P 21/34; H02K 2201/12; H02P 2207/05

(57) ABSTRACT

Embodiments described herein relate to systems and methods for controlling a switched reluctance motor with double-layer toroidal winding. A control system for a motor includes: a switched reluctance motor including: a rotor including a plurality of salient poles, and a stator disposed concentrically with the rotor, the stator including a plurality of slots on a stator core, each of the plurality of slots accommodating a first coil and a second coil, each wound around the stator core in a toroidal configuration between directly adjacent stator teeth, each of the first and second coils respectively forming stator poles, and a drive circuit including a transistor and a diode, the drive circuit being configured to independently excite the first coil and the second coil by providing at least one of positive or negative currents to each of the first and second coils bi-directionally or single directionally.

### CROSS-REFERENCE TO RELATED APPLICATION(S)

This application claims the benefit of and priority to U.S. Provisional Patent Application No. 63/761,686, filed on Feb. 21, 2025, the entirety of which is incorporated herein for all purposes.

### TECHNICAL FIELD

Embodiments described herein relate to systems and methods for controlling a switched reluctance motor with a double-layer toroidal winding.

### SUMMARY

A reluctance motor is an electric motor in which torque is produced by the tendency of its moveable part to move to a position where the reluctance of the magnetic circuit is minimized. A switched reluctance (SR) motor is a type of reluctance motor in which portions of the magnetic circuit are energized based on the position of the moveable part. Based on the timing of the energizing, this can increase or decrease the movement of the moveable part. Typically, the timing of the energizing is determined by the relationship of the winding inductance with respect to the position of the moveable part. In a conventional SR motor construction with concentrated stator tooth wound coils, this relationship is determined by the self-inductance of the winding. In an SR motor construction with full-pitch, fractional pitch, or toroidal wound coils, this relationship is determined by the mutual inductance of the winding. This mutually coupled relationship for torque production has afforded the opportunity for control methods that benefit overall system metrics, such as size, cost, and thermal management, extending not only to the motor but also to the converter. A double-layer winding allows the most control flexibility of the described options. Embodiments described herein provide systems and methods for controlling a mutually coupled switched reluctance motor with a double-layer winding.

In example embodiments of the present disclosure, instead of one coil being wound around each stator tooth (“conventional short-pitch concentrated winding”), pairs of coils are wound around the stator back iron on each side of each stator tooth (“double-layer”). A motor having coils wound around the stator back iron with two windings adjacent to each other in each winding location between adjacent stator teeth is referred to herein as a “double-layer toroidal winding motor.” The control process according to embodiments of the present disclosure allow higher utilization of the power electronic components by enabling any number of the electrically separate coils to share the load of the energized phase, effectively increasing the duty cycle of an individual insulated gate bipolar transistor (IGBT)/switch up to a theoretical maximum of 100 percent (100%). By relatively increasing the utilization of the power electronics, the system designer has more design freedom and flexibility of options. For example, the motor can be made smaller, and/or the converters can be made smaller, and/or the number of parallel-connected converters can be decreased.

In one embodiment, a control system for a motor includes: a switched reluctance motor including: a rotor including a plurality of salient poles, and a stator disposed concentrically with the rotor, the stator including a plurality of slots on a stator core, each of the plurality of slots accommodating a first coil and a second coil, each wound around the stator core in a toroidal configuration, each of the first and second coils respectively forming stator poles, and a drive circuit including a transistor and a diode, the drive circuit being configured to independently excite the first coil and the second coil by providing at least one of positive or negative currents to each of the first and second coils bi-directionally or single directionally at appropriate timings.

In another embodiment, a control system for a motor includes: a switched reluctance motor including: a rotor including a plurality of salient poles, and a stator disposed concentrically with the rotor, the stator including a plurality of slots on a stator core, each of the plurality of slots accommodating a first coil and a second coil, each of the first coil and the second coil being wound around the stator core in a toroidal configuration, each of the first coil and the second coil respectively forming a plurality of stator poles, and a drive circuit including at least two independently controlled circuits that control currents, wherein the first coil and the second coil in a same slot are independently excited by providing at least one of positive or negative currents from the drive circuit at appropriate timings, and wherein the drive circuit is configured to supply the currents to each of the first coil and the second coil in the plurality of slots bi-directionally or in single direction so that, in addition to excitation of the first coil and the second coil for a phase, excitations for N phases are performed simultaneously to form a single magnetic flux loop, where N is an integer greater than 0.

In another embodiment, a method is provided for controlling a switched reluctance motor including a rotor with a plurality of salient poles, and a stator disposed concentrically with the rotor, the stator including a plurality of teeth on a stator core, a first coil and a second coil, each wound around the stator core in a toroidal configuration between directly adjacent stator teeth, each of the first and second coils respectively forming stator poles, and a drive circuit including a transistor and a diode. The method includes independently exciting the first coil and the second coil by the drive circuit providing positive and/or negative currents to each of the first and second coils bi-directionally or single directionally.

Other aspects of the embodiments will become apparent by consideration of the detailed description and accompanying drawings.

### BRIEF DESCRIPTION OF THE DRAWINGS

FIG. 1 illustrates various views of a double-layer toroidal winding motor in accordance with an example embodiment of the present disclosure.

FIG. 2 is an end view of the double-layer toroidal winding motor of FIG. 1 with operational notations in accordance with an example embodiment of the present disclosure.

FIG. 3 is a diagram showing definitions of coil designations in accordance with an example embodiment of the present disclosure.

FIG. 4 shows a diagram of first and second group controller circuits and respective circuit diagrams therefor in accordance with an example embodiment of the present disclosure.

FIG. 5 is a circuit diagram showing a basic unit circuit for a single-directional control operation in accordance with an example embodiment of the present disclosure.

FIG. 6 illustrates schematic views of the double-layer toroidal winding motor of FIG. 1 with operational notations in accordance with an example embodiment of the present disclosure.

FIG. 7 is a control timing diagram for a single-directional control operation in accordance with an example embodiment of the present disclosure.

FIG. 8 illustrates schematic views of the double-layer toroidal winding motor of FIG. 1 with operational notations in accordance with an example embodiment of the present disclosure.

FIG. 9 is a control timing diagram for a bi-directional control operation in accordance with an example embodiment of the present disclosure.

FIG. 10 is a circuit diagram showing a basic unit circuit for a bi-directional control operation in accordance with an example embodiment of the present disclosure.

FIG. 11 illustrates diagrams showing definitions of coil designations in accordance with an example embodiment of the present disclosure.

FIG. 12 shows a diagram of first and second group controller circuits and respective circuit diagrams therefore in accordance with an example embodiment of the present disclosure.

### DETAILED DESCRIPTION

Before any embodiments are explained in detail, it is to be understood that the embodiments are not limited in application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more electronic processors, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “appropriate,” “approximately,” “about,” and “substantially” as used herein represent a duration or an amount close to the stated duration or amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

### Single Directional Control

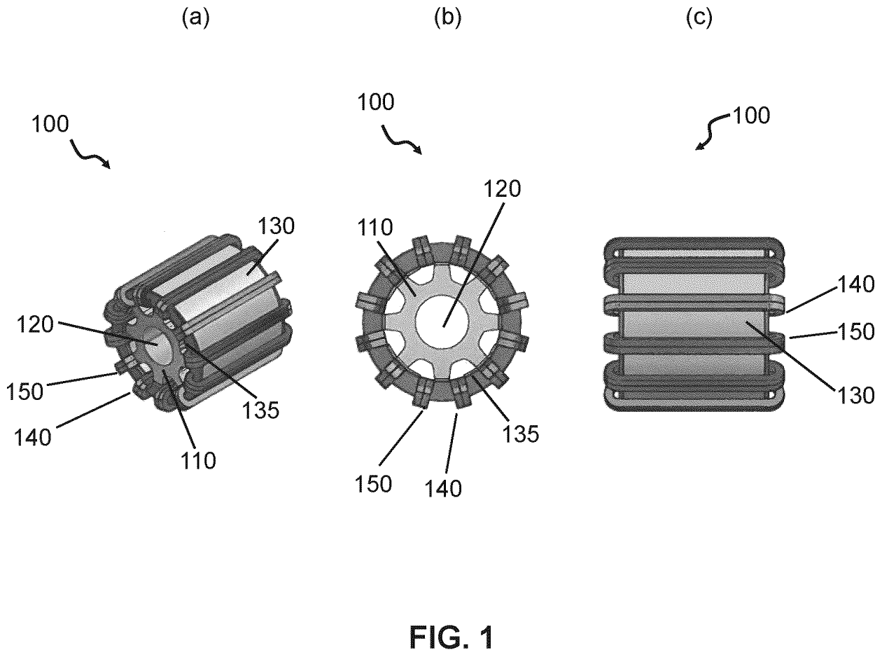

FIG. 1 illustrates various views of a double-layer toroidal winding motor in accordance with an example embodiment of the present disclosure.

With reference to FIG. 1, part (a) shows a perspective view of a double-layer toroidal winding motor 100 in accordance with an example embodiment of the present disclosure. Part (b) shows a front view of the double-layer toroidal winding motor 100. Part (c) shows a side view of the double-layer toroidal winding motor 100. The double-layer toroidal winding motor 100 may include a rotor 110 surrounding a bore for a central shaft 120. A stator back iron 130 may surround the rotor 110, and may include a plurality of inward-protruding stator teeth 135. A first coil layer 140 and a second coil layer 150 may be wound around the stator back iron 130. The windings of the first coil layer 140 and a second coil layer 150 may be arranged on both sides of the inward-protruding stator teeth 135 around the stator back iron 130.

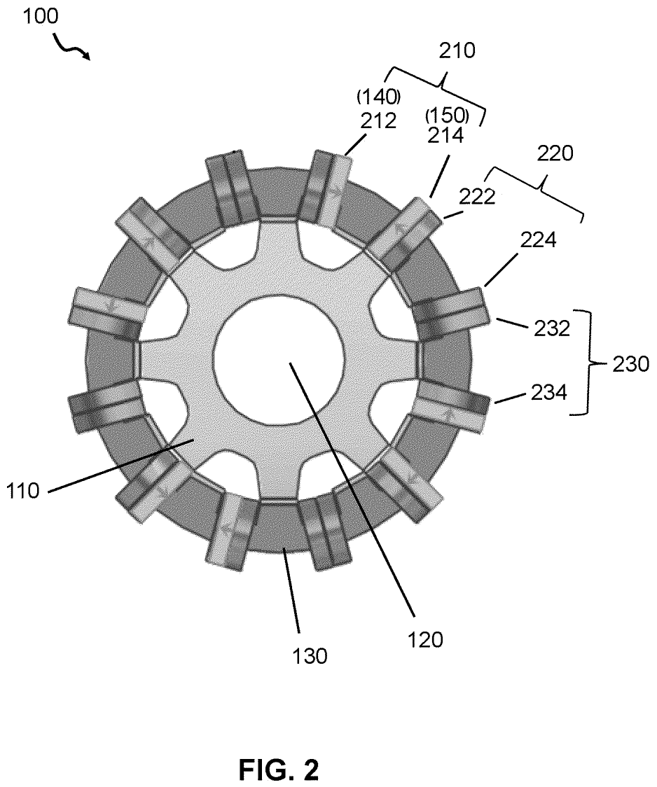

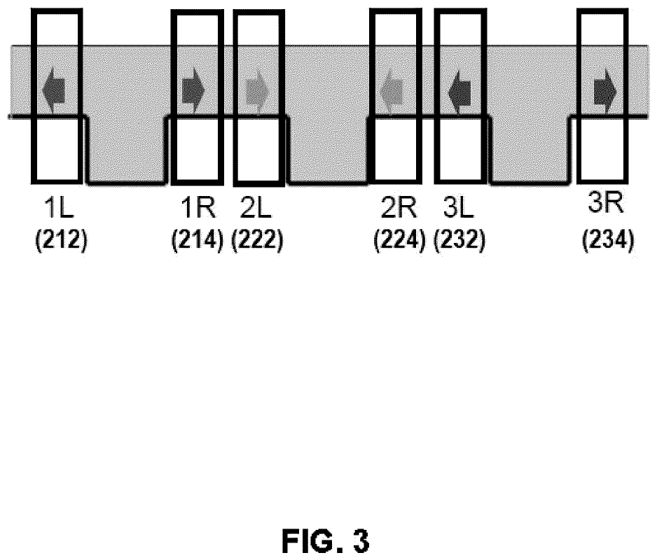

FIG. 2 is an end view of the double-layer toroidal winding motor of FIG. 1. With reference to FIG. 2, in operation, each winding of the first coil layer 140 and the second coil layer 150 may be energized independently. A first group of windings 210 may include first left group windings 212 and first right group windings 214, which are adjacent to one another disposed on opposite sides of a corresponding stator tooth 135. There are left group windings 1L, 2L, 3L, . . . (see FIG. 3) and right group windings 1R, 2R, 3R, . . . (see FIG. 3). The first left group windings 212 and first right group windings 214 may be or may not be energized with opposite polarity directions. Arrows show the direction of flux for each winding. A second group of windings 220 may also include second left group windings 222 and second right group windings 224. A third group of windings 230 may also include third left group windings 232 and third right group windings 234. FIG. 3 shows examples of left (1L, 2L, 3L, . . . ) and right (1R, 2R, 3R, . . . ) pairings of windings, (1L/1R, 2L/2R, 3L/3R). As can be seen in FIG. 3, in this specific phase, each member of any given pair may be energized in opposite directions for a single-directional motor control operation. However, the energized directions are frequently changed depends on the flux path to be formed. It should be appreciated that the terms “left” and “right” are used herein for convenience and are nonlimiting designations. Furthermore, the number of windings and groups is shown in the drawings as an example, but embodiments are not limited thereto.

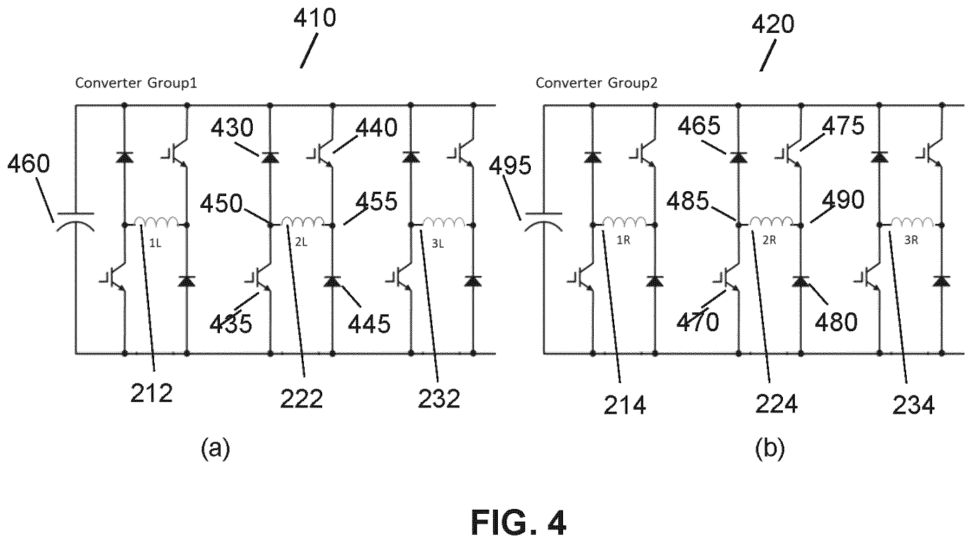

FIG. 4 shows a diagram of first and second group controller circuits and respective circuit diagrams therefore in accordance with an example embodiment of the present disclosure.

With reference to FIG. 4, part (a) shows a first controller circuit 410 that may control all of the left group windings, e.g., first left group winding 212, second left group winding 222, and third left group winding 232 of FIG. 2, although only first through third left group windings 212, 222, 232 are shown in FIG. 4 for convenience of explanation. Part (b) of FIG. 4 shows a second controller circuit 420 that may control all of the right group windings, e.g., first right group winding 214, second right group winding 224, and third right group winding 234 of FIG. 2.

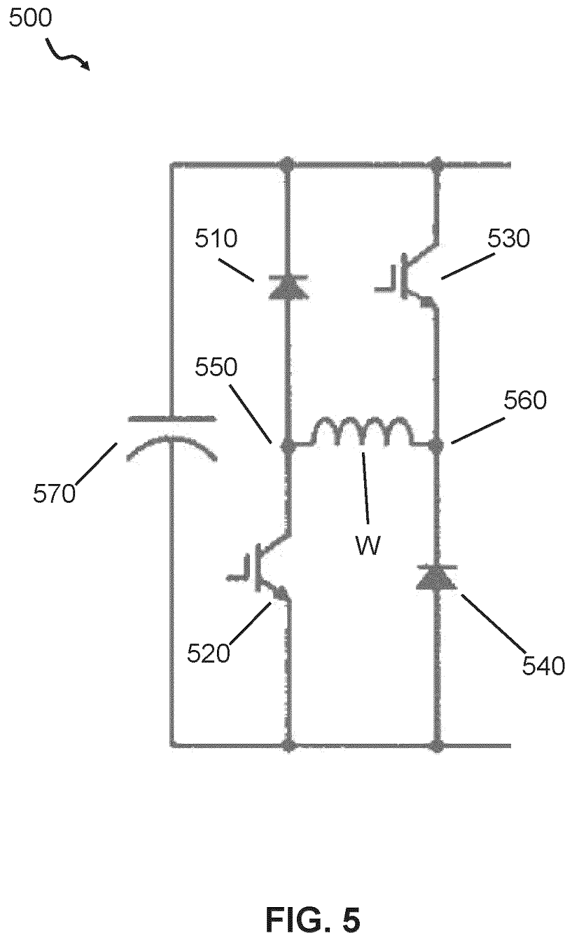

FIG. 5 is a circuit diagram showing a basic unit circuit for a single-directional control operation in accordance with an example embodiment of the present disclosure. As shown in FIG. 4, part (a), each individual left winding may be controlled by subcircuit 500 shown in FIG. 5. Referring again to FIG. 4, the first controller circuit 410 may include a first diode 430 connected in series with a first transistor 435 between a high voltage and a low voltage, and a second transistor 440 connected in series with a second diode 445 between the high voltage and the low voltage, with the corresponding winding being connected between the first diode 430 and the first transistor 435 at a first node 450 and connected between the second transistor 440 and the second diode 445 at a second node 455. The transistors 435, 440 may receive respective gate inputs that may control the operation of the transistors 435, 440. A power source 460 may provide power to the first controller circuit 410.

Similarly, as shown in FIG. 4, part (b), each individual right winding may be controlled by subcircuit 500 shown in FIG. 5. Referring again to FIG. 4, the second controller circuit 420 may include a first diode 465 connected in series with a first transistor 470 between a high voltage and a low voltage, and a second transistor 475 connected in series with a second diode 480 between the high voltage and the low voltage, with the corresponding winding being connected between the first diode 465 and the first transistor 470 at a first node 485 and connected between the second transistor 475 and the second diode 480 at a second node 490. The transistors 470, 475 may receive respective gate inputs that may control the operation of the transistors 470, 475. A power source 495 may provide power to the second controller circuit 420.

The FIG. 5 example shows a basic circuit unit 500 that may be used for the single-directional control in accordance with an example embodiment. The circuit unit 500 may include a first diode 510 connected in series with a first transistor 520 between a high voltage and a low voltage, and a second transistor 530 connected in series with a second diode 540 between the high voltage and the low voltage, with a winding W being connected between the first diode 510 and the first transistor 520 at a first node 550 and connected between the second transistor 530 and the second diode 540 at a second node 560. The transistors 520, 530 may receive respective gate inputs that may control the operation of the transistors 520, 530. A power source 570 may provide power to the circuit unit 500. The circuit unit 500 may be repeated as necessary for each phase being controlled. For example, at least six phases, e.g., three phases for each of the left and the right groups, may be controlled as shown in the FIG. 4 example.

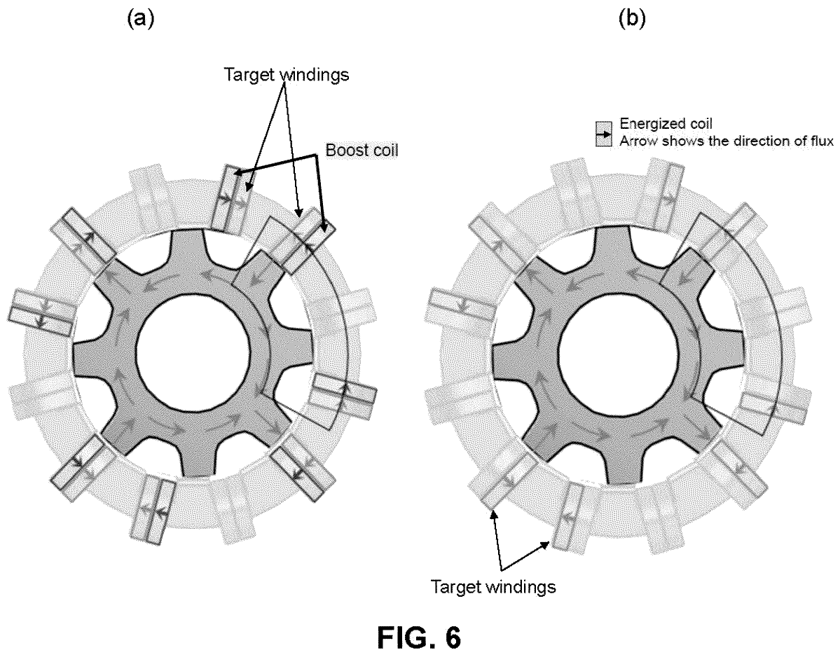

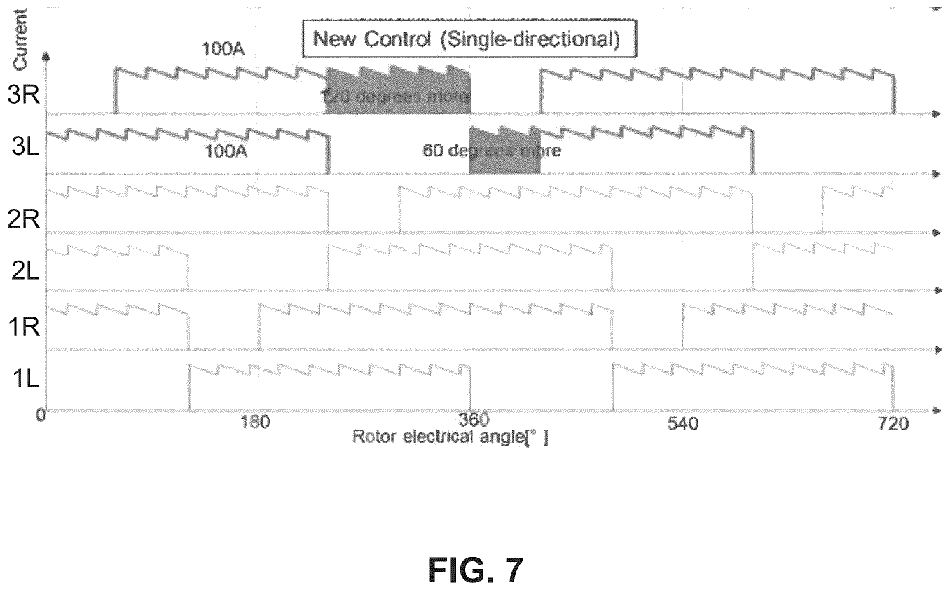

FIG. 6 illustrates schematic views of the double-layer toroidal winding motor of FIG. 1 with operational notations in accordance with an example embodiment of the present disclosure. FIG. 6 shows a control method using the first controller circuit 410 and the second controller circuit 420 in which other coils are also energized when a phase is energized. As such, this control method uses a respective “boost” coil on either side of the target pair of windings, as labeled in part (a). This means that the conduction period will be wider than conventional control per each coils (or phases), while the flux is reinforced. Using these boost coils may decrease peak current to obtain the same amount of torque compared to a control that does not use boost coils, as shown in part (b). FIG. 7 shows an example control timing diagram for the single-directional control operation of the circuit 500 of FIG. 5. In FIG. 7, an example is shown in which a right coil winding 2R is energized longer and later than in the conventional control timing, and a left coil winding 2L is energized sooner and lasts shorter than in the conventional control timing.

### Bi-Directional Control

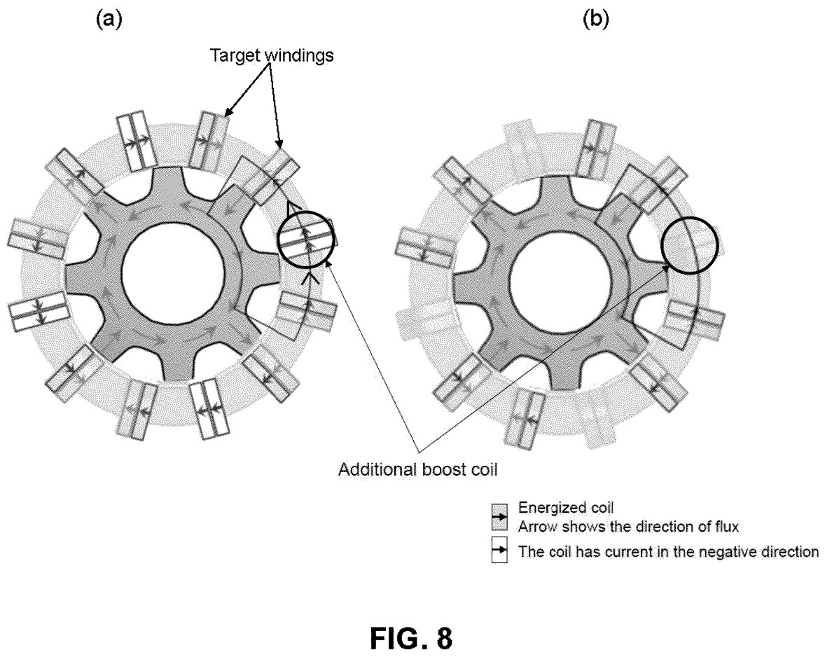

FIG. 8 illustrates schematic views of the double-layer toroidal winding motor of FIG. 1 with operational notations in accordance with an example embodiment of the present disclosure. In an example embodiment, more energized coils may be added in a flux path using a circuit that allows current to switch its direction. For example, with reference to FIG. 8, part (b) shows a control notation for a single-directional control in accordance with an example embodiment, and part (a) shows a control notation for a bi-directional control in accordance with an example embodiment. The part (a) bi-directional control energizes an additional pair of windings as another boost coil, which is not energized in the part (b) single-directional example. Using a bi-directional control in accordance with an example embodiment, coils can be excited with a 100% duty cycle, although embodiments are not limited thereto.

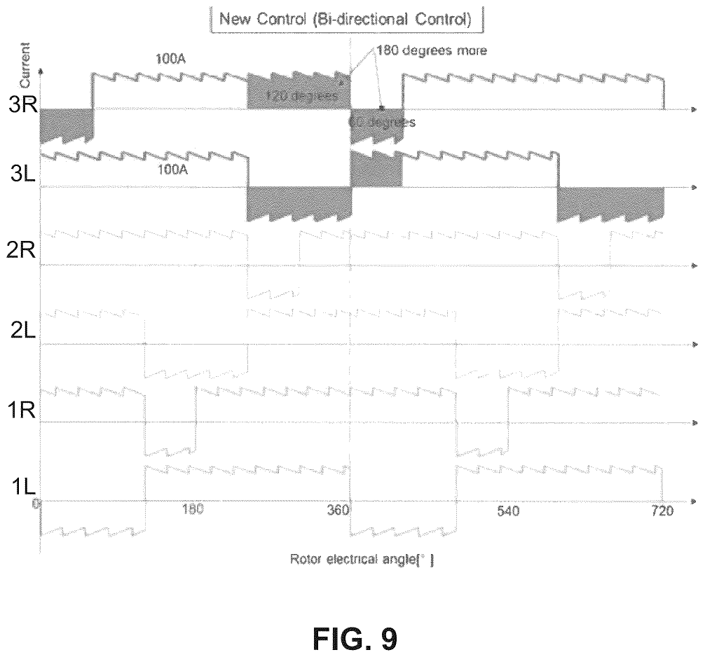

FIG. 9 shows an example control timing diagram for the bi-directional control operation of the motor shown in FIG. 8, although only first and second pairs of the windings 1L, 1R, 2L, and 2R are shown in FIG. 9 for convenience of explanation. In FIG. 9, an example is shown in which a right coil winding 2R is energized longer than in the conventional control timing, and the direction of the current may be changed part way through the energization, with a 100% duty cycle. A left coil winding 2L is energized longer than in the conventional control timing, and the direction of the current may be changed part way through the energization, with a 100% duty cycle.

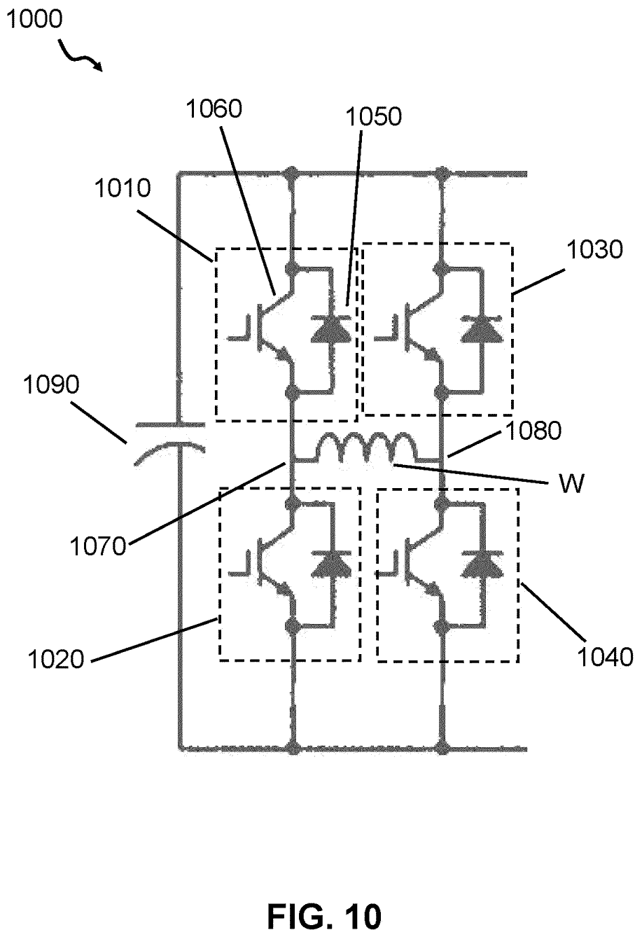

FIG. 10 is a circuit diagram showing a basic unit circuit for a bi-directional control operation in accordance with an example embodiment of the present disclosure.

The FIG. 10 example shows a basic circuit unit 1000 that may be used for the bi-directional control in accordance with an example embodiment. The circuit unit 1000 may include four diode-transistor pairs 1010, 1020, 1030, 1040, each including a diode 1050 connected in parallel with a respective transistor 1060, for example, an insulated Gate Bipolar Transistor (IGBT). The first diode-transistor pair 1010 may be connected in series with the second diode-transistor pair 1020 between a high voltage and a low voltage, and the third diode-transistor pair 1030 may be connected in series with the fourth diode-transistor pair 1040 between the high voltage and the low voltage, with a winding W being connected between the first diode-transistor pair 1010 and the second diode-transistor pair 1020 at a first node 1070 and connected between the third diode-transistor pair 1030 and the fourth diode-transistor pair 1040 at a second node 1080. Each transistor 1060 may receive a respective gate input that may control the operation of each transistor 1060. A power source 1090 may provide power to the circuit unit 1000. Accordingly, when the transistors 1060 of the second and third diode-transistor pairs 1020, 1030 are turned on, the current flows from the second node 1080 to the first node 1070 (first, positive, or forward direction), and when the transistors 1060 of the first and fourth diode-transistor pairs 1010, 1040 are turned on, the current flows from the first node 1070 to the second node 1080 (second, negative, or backward direction). The circuit unit 1000 may be repeated as necessary for each phase being controlled. For example, at least six phases, e.g., three phases for each of the left and the right groups, may be controlled.

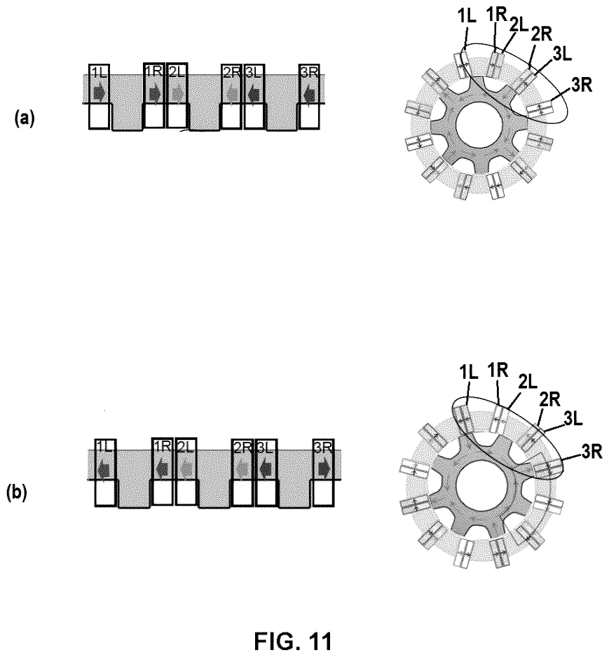

FIG. 11 is a diagram showing definitions of coil designations in accordance with an example embodiment of the present disclosure. FIG. 11 shows examples of left (1L, 2L, 3L . . . ) and right (1R, 2R, 3R, . . . ) pairings of windings. As can be seen in FIG. 11, each member of any given pair may be energized in the same or in opposite directions. In part (a), a first state is shown with a first set of energization directions. In part (b), a second state is shown with a second set of energization directions. While this control transition may be similar to conventional control method to energize each phase, it should be noted that the windings of 1L and 3R are excited in the opposite directions from each other.

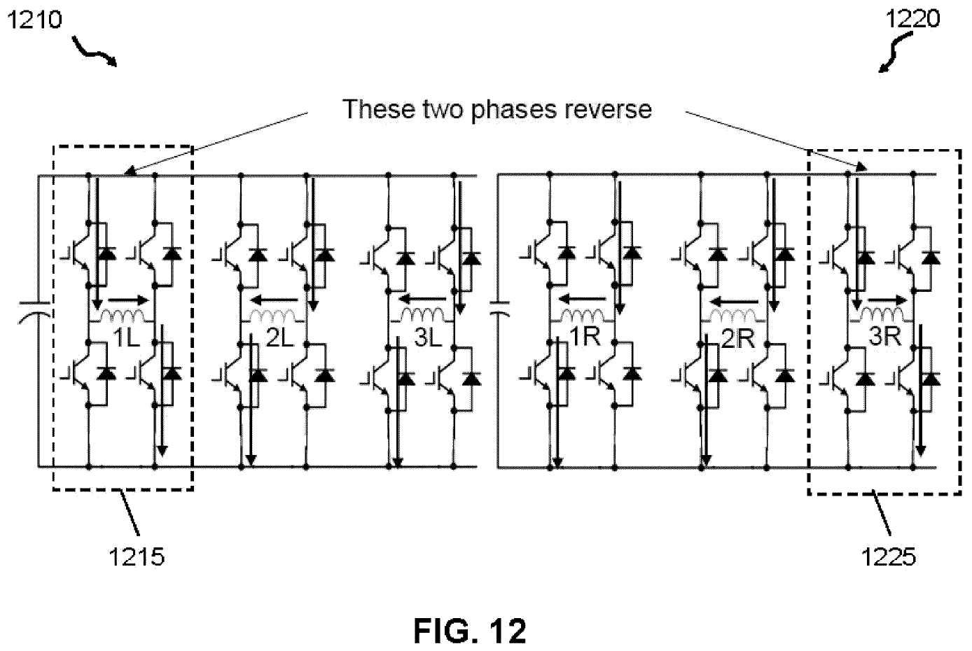

FIG. 12 shows a diagram of first and second group controller circuits and respective circuit diagrams for a bi-directional control operation. In the FIG. 12 example, a direction of current flow is shown by arrows, which illustrates the current directions as shown in FIG. 11, part (a). In FIG. 12, a left group is shown in circuit 1210, and a right group is shown in circuit 1220. In the FIG. 12 example, six circuit units are illustrated, but embodiments are not limited thereto.

An example control system for a motor in accordance with an embodiment of the present disclosure may include a switched reluctance motor having a rotor with a plurality of salient poles, and a stator disposed centrically with the rotor, having a plurality of slots on a stator core, each of the plurality of slots accommodating a first coil and a second coil each wound around the stator core in a toroidal configuration, and each of the first and second coils respectively forming stator poles, and a drive circuit having a transistor and a diode. The first coil and second coil may be independently excited by providing positive and/or negative currents from the drive circuit at appropriate timings. The drive circuit may be configured to supply currents to each of the first and second coils bi-directionally or single directionally.

An example control system for a motor in accordance with an embodiment of the present disclosure may include a switched reluctance motor having a rotor with a plurality of salient poles, and a stator disposed centrically with the rotor, having a plurality of slots on a stator core, each of the plurality of slots accommodating a first coil and a second coil each wound around the stator core in a toroidal configuration, and each of the first and second coils respectively forms stator poles, and a drive circuit having at least two circuits that control currents. A number of the plurality of salient poles may be smaller than a number of the plurality of slots. The first coil and second coil in a same slots may be independently excited by providing positive and negative currents from the drive circuit at appropriate timings. The drive circuit may be configured to supply currents to each of the first and second coils in the plurality of slots bi-directionally or single direction so that, in addition to excitation of the first and second coils for a phase, excitations for N phases may be performed simultaneously to form a single magnetic flux loop, where N is an integer.

An example control system for a motor in accordance with an embodiment of the present disclosure may include a switched reluctance motor having a rotor with a plurality of salient poles, a stator disposed centrically with the rotor, having a plurality of recesses on a stator core, each of the plurality of recesses accommodating a pair of coils each wound around the stator core in a toroidal configuration, and each of the pair of coils respectively forms a first stator pole and a second stator pole, and is independently excited. A number of the plurality of salient poles may be smaller than a number of the plurality of recesses. The first stator pole may be excited by providing a first positive current and a first negative current to one of the pair of coils, while the second stator pole may be excited by providing a second positive current and a second negative current to another of the pair of coils. An excitation start angle of the first positive current may be delayed from an excitation start angle of the second positive current by a first prescribed angle. An excitation end angle of the first positive current may be delayed from an excitation end angle of the second positive current by a second prescribed angle. A sum of the first prescribed angle and the second prescribed angle may be equal to or larger than 180°, but is not limited thereto.

An example control system for a motor in accordance with an embodiment of the present disclosure may include a switched reluctance motor having a rotor with a plurality of salient poles, a stator disposed centrically with the rotor, having a plurality of recesses on a stator core, each of the plurality of recesses accommodating a pair of coils each wound around the stator core in a toroidal configuration, and each of the pair of coils respectively forms a first stator pole and a second stator pole, and is independently excited, and a drive circuit having a plurality of invertor circuits each including a transistor and a clamp diode. A number of the plurality of salient poles may be smaller than a number of the plurality of recesses. First positive current and first negative current may be alternately applied to one of the pair of coils by the drive circuit, while second positive current and second negative current may be alternatively applied to another of the pair of coils by the drive circuit. A duration of the first positive current may be longer than a duration of the second positive current. A duration of the first negative current may be shorter than a duration of the second negative current. An excitation start angle of the first positive current may be delayed from an excitation start angle of the second positive current by 60°. An excitation end angle of the first positive current may be delayed from an excitation end angle of the second positive current by 120°.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used to temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A control system for a motor, comprising:
a switched reluctance motor comprising:
a rotor comprising a plurality of salient poles; and
a stator disposed concentrically with the rotor, the stator comprising a plurality of slots on a stator core, each of the plurality of slots accommodating a first coil and a second coil, each wound around the stator core in a toroidal configuration between directly adjacent stator teeth, each of the first and second coils respectively forming stator poles; and
a drive circuit comprising a transistor and a diode, the drive circuit being configured to independently excite the first coil and the second coil by providing at least one of positive or negative currents to each of the first and second coils bi-directionally or single directionally.

2. The system of claim 1, wherein the drive circuit comprises:
a power source;
a first control circuit unit configured to control the first coil, the first control circuit unit comprising:
a first diode connected in series with a first transistor between a high voltage and a low voltage of the power source; and
a second transistor connected in series with a second diode between the high voltage and the low voltage,
wherein a winding of the first coil is connected between the first diode and the first transistor at a first node, and is connected between the second transistor and the second diode at a second node; and
a second control circuit unit configured to control the second coil, the second control circuit unit comprising:
a third diode connected in series with a third transistor between the high voltage and the low voltage of the power source; and
a fourth transistor connected in series with a fourth diode between the high voltage and the low voltage,
wherein a winding of the second coil is connected between the third diode and the third transistor at a third node, and is connected between the fourth transistor and the fourth diode at a fourth node, and
wherein each of the first to fourth transistors is configured to receive a respective enabling signal at its gate input to control operation of the transistor.

3. The system of claim 2, wherein each of a number of the first control circuit unit and a number of the second control circuit unit is same as a number of control phases of the system.

4. The system of claim 1, wherein:
the drive circuit comprises:
a power source; and
a control circuit unit configured to control a corresponding winding of the first coil or the second coil, the control circuit unit comprising first to fourth diode-transistor pairs, each of the first to fourth diode-transistor pairs comprising a diode connected in parallel with a transistor, each transistor being configured to receive a respective enabling signal at its gate input to control operation of the transistor;
the first diode-transistor pair is connected in series with the second diode-transistor pair between a high voltage and a low voltage of the power source;
the third diode-transistor pair is connected in series with the fourth diode-transistor pair between the high voltage and the low voltage; and
the corresponding winding is connected between the first diode-transistor pair and the second diode-transistor pair at a first node, and is connected between the third diode-transistor pair and the fourth diode-transistor pair at a second node.

5. The system of claim 4, wherein:
at least a first control circuit unit is configured to control the first coil; and
at least a second control circuit unit is configured to control the second coil.

6. The system of claim 4, wherein a number of the control circuit unit is the two times a number of control phases of the system.

7. A control system for a motor, comprising:
a switched reluctance motor comprising:
a rotor comprising a plurality of salient poles; and
a stator disposed concentrically with the rotor, the stator comprising a plurality of slots on a stator core, each of the plurality of slots accommodating a first coil and a second coil, each of the first coil and the second coil being wound around the stator core in a toroidal configuration, each of the first coil and the second coil respectively forming a plurality of stator poles; and
a drive circuit comprising at least two independently controlled circuits that control currents,
wherein a first winding of the first coil and a first winding of the second coil in a same slot are independently excited by providing at least one of positive or negative currents from the drive circuit at appropriate timings, and
wherein the drive circuit is configured to supply the positive and negative currents to each of the first coil and the second coil in the plurality of slots bi-directionally or in single direction so that, in addition to excitation of the first coil and the second coil for a phase, excitations for N phases are performed simultaneously to form a single magnetic flux loop, N being an integer greater than 0.

8. The system of claim 7, wherein:
a first stator pole, among the plurality of stator poles, is excited by providing a first positive current and a first negative current to one of the first coil or the second coil; and
a second stator pole, among the plurality of stator poles, is excited by providing a second positive current and a second negative current to another of the first coil or the second coil.

9. The system of claim 8, wherein an excitation start angle of the first positive current is delayed from an excitation start angle of the second positive current by a first prescribed angle.

10. The system of claim 9, wherein an excitation end angle of the first positive current is delayed from an excitation end angle of the second positive current by a second prescribed angle.

11. The system of claim 10, wherein a sum of the first prescribed angle and the second prescribed angle is greater than or equal to 180°.

12. The system of claim 10, wherein an excitation start angle of the first positive current is delayed from an excitation start angle of the second positive current by 60°.

13. The system of claim 12, wherein an excitation end angle of the first positive current is delayed from an excitation end angle of the second positive current by 120°.

14. The system of claim 8, wherein a duration of the first positive current is longer than a duration of the second positive current.

15. The system of claim 14, wherein a duration of the first negative current is shorter than a duration of the second negative current.

16. A method for controlling a switched reluctance motor comprising a rotor comprising a plurality of salient poles, and a stator disposed concentrically with the rotor, the stator comprising a plurality of teeth on a stator core, a first coil and a second coil, each wound around the stator core in a toroidal configuration between directly adjacent stator teeth, each of the first and second coils respectively forming stator poles, and a drive circuit comprising a transistor and a diode, the method comprising:
independently exciting the first coil and the second coil by the drive circuit providing positive and negative currents to each of the first and second coils bi-directionally.

17. The method of claim 16, wherein an excitation start angle of a first positive current is delayed from an excitation start angle of a second positive current by a first prescribed angle.

18. The method of claim 17, wherein an excitation end angle of a first positive current is delayed from an excitation end angle of a second positive current by a second prescribed angle.

19. The method of claim 18, wherein a sum of the first prescribed angle and the second prescribed angle is greater than or equal to 180°.

20. The method of claim 18, wherein an excitation start angle of the first positive current is delayed from an excitation start angle of the second positive current by 60°.

21. The method of claim 20, wherein an excitation end angle of the first positive current is delayed from an excitation end angle of the second positive current by 120°.

22. The method of claim 16, wherein:
a duration of the first positive current is longer than a duration of the second positive current; and
a duration of the first negative current is shorter than a duration of the second negative current.
